(19) United States
(12) Patent Application Publication
(10) Pub. No.: US 2021/0053131 A1
(43) Pub. Date: Feb. 25, 2021

(54) ELECTRIC DISCHARGE MACHINING OIL COMPOSITION, METHOD FOR MANUFACTURING ELECTRIC DISCHARGE MACHINING OIL COMPOSITION, AND ELECTRIC DISCHARGE MACHINING METHOD

(71) Applicant: Idemitsu Kosan Co.,Ltd., Chiyoda-ku (JP)

(72) Inventors: Takashi KONDO, Chiba (JP); Tomohiko KITAMURA, Chiba (JP)

(73) Assignee: Idemitsu Kosan Co.,Ltd., Chiyoda-ku (JP)

(21) Appl. No.: 16/982,828

(22) PCT Filed: Mar. 26, 2019
(86) PCT No.: PCT/JP2019/012797

§ 371 Date: Sep. 21, 2020

(30) Foreign Application Priority Data
Mar. 28, 2018 (JP) 2018-061675

(51) Int. Cl. B23H 1/08; C10M 143/14; C10M 169/04

(52) U.S. Cl. CPC B23H 1/08; C10N 2030/02; C10M 169/041; C10M 143/14

(57) ABSTRACT

The present invention relates to an electric discharge machining oil composition and an electric discharge machining method capable of enhancing machining speed in electric discharge machining. This electric discharge machining oil composition is characterized by including (A) a base oil, and (B) one or more types of petroleum resin selected from hydrogenated products of copolymers of dicyclopentadiene and an aromatic compound and having a softening point of 75 to 185° C. and a mean molecular weight (Mn) of 670 to 3000, wherein the kinematic viscosity of the electric discharge machining oil composition at 40° C. is 1 to 10 mm²/s. Further, the electric discharge machining method is characterized by employing said electric discharge machining oil composition, and includes interposing the electric discharge machining oil composition between a workpiece and an electrode, and generating an electric discharge between the workpiece and the electrode in this state to machine the workpiece.

### TECHNICAL FIELD

The present invention relates to an electric discharge machining oil composition, a method for producing the electric discharge machining oil composition, and an electric discharge machining method.

### BACKGROUND ART

As factors which affect the machining efficiency of electric discharge machines, control of electrical conditions, the servo method, electrode materials, etc. have been studied and significantly improved. Further, though it had been considered that an electric discharge machining liquid is a secondary factor, the importance of additives was recognized recently, and researches thereof have been conducted. Specifically, electric discharge machining liquids obtained by using a conventional low-viscosity mineral oil and synthetic oil and blending various additives therein have been reported.

For example, electric discharge machining liquids, wherein at least one high-molecular-weight compound is added to a low-viscosity mineral oil, and wherein the characteristic temperature in the cooling performance test based on JIS K 2242 is 450° C. or higher, have been reported (Patent Documents 1 and 2, etc.).

### PRIOR ART DOCUMENTS

### Patent Documents

Patent Document 1: Japanese Laid-Open Patent Publication No. H06-155165
Patent Document 2: Japanese Laid-Open Patent Publication No. 2007-38364

### SUMMARY OF THE INVENTION

### Problems to be Solved by the Invention

These conventional electric discharge machining liquids exert excellent effects with respect to electric discharge machining performance, but there is still a room for improvement with respect to the machining speed.

Under such circumstances, it has been desired to provide an electric discharge machining oil composition which can improve the machining speed in electric discharge machining.

### Means for Solving the Problems

The present invention relates to an electric discharge machining oil composition, a method for producing the electric discharge machining oil composition and an electric discharge machining method described below.

[1] An electric discharge machining oil composition comprising:

a base oil (A); and

at least one petroleum resin (B), which is selected from hydrogenated products of copolymers of dicyclopentadiene and an aromatic compound, and which has a softening point of 75 to 185° C. and a number-average molecular weight (Mn) of 670 to 3000, wherein the kinetic viscosity of the electric discharge machining oil composition at 40° C. is 1 to 10 mm²/s.

[2] The electric discharge machining oil composition according to item [1], wherein the content of an aromatic compound unit in the component (B) is 0 to 50% by mass based on the aromatic compound.
[3] The electric discharge machining oil composition according to item [1] or [2], wherein the hydrogenated product of the copolymer of dicyclopentadiene and the aromatic compound in the component (B) is a partially hydrogenated product or a completely hydrogenated product.
[4] The electric discharge machining oil composition according to any one of items [1] to [3], wherein the hydrogenated product of the copolymer of dicyclopentadiene and the aromatic compound in the component (B) has a bromine number of 0 to 40 g/100 g.
[5] The electric discharge machining oil composition according to any one of items [1] to [4], wherein the total content of the component (B) is 1 to 20% by mass based on the total amount of the electric discharge machining oil composition.
[6] The electric discharge machining oil composition according to any one of items [1] to [5], wherein the total content of the component (A) is 70 to 99% by mass based on the total amount of the electric discharge machining oil composition.
[7] The electric discharge machining oil composition according to any one of items [1] to [6], which has a kinetic viscosity at 40° C. of 1.2 to 8 mm²/s.
[8] The electric discharge machining oil composition according to any one of items [1] to [7], wherein the component (A) comprises a low-viscosity base oil having a kinetic viscosity at 40° C. of 1 to 5 mm²/s and a medium-viscosity base oil having a kinetic viscosity at 40° C. of more than 5 mm²/s but 100 mm²/s or less.
[9] A method for producing an electric discharge machining oil composition comprising:

a base oil (A); and

at least one petroleum resin (B), which is selected from hydrogenated products of copolymers of dicyclopentadiene and an aromatic compound, and which has a softening point of 75 to 185° C. and a number-average molecular weight (Mn) of 670 to 3000, wherein the kinetic viscosity of the electric discharge machining oil composition at 40° C. is 1 to 10 mm²/s,

the method including mixing the component (A) and the component (B).

[10] An electric discharge machining method, which includes interposing the electric discharge machining oil composition according to any one of items [1] to [8] between a workpiece and an electrode, and generating an electric discharge between the workpiece and the electrode in this state to machine the workpiece.

### Advantageous Effect of the Invention

The present invention can provide an electric discharge machining oil composition which is suitably used as an electric discharge machining liquid.

According to a preferred embodiment of the present invention, the electric discharge machining oil composition of the present invention has a short vapor film length and excellent thermal conductivity. For this reason, it is considered that the machining speed in electric discharge machining can be improved thereby.

### BRIEF DESCRIPTION OF THE DRAWINGS

FIG. 1 shows a processing machine used in the Examples.

FIG. 2 is a graph showing the relationship between the vapor film length in the cooling performance test and the machining speed.

### BEST MODE FOR CARRYING OUT THE INVENTION

Hereinafter, embodiments of the present invention will be described in detail.

1. Electric discharge machining oil composition

The electric discharge machining oil composition of the present invention is characterized in that it comprises: a base oil (A); and at least one petroleum resin (B), which is selected from hydrogenated products of copolymers of dicyclopentadiene and an aromatic compound, and which has a softening point of 75 to 185° C. and a number-average molecular weight (Mn) of 670 to 3000, wherein the kinetic viscosity of the electric discharge machining oil composition at 40° C. is 1 to 10 mm²/s. Hereinafter, the respective components will be described in detail.

### (A) Base oil

The base oil to be used in the present invention is not particularly limited, and any material may be suitably selected from among mineral oils and synthetic oils which are conventionally used as abase oil of an electric discharge machining oil. For example, at least one selected from the group consisting of mineral oils and synthetic oils is preferably used. As the base oil to be used in the present invention, only one of a mineral oil and a synthetic oil may be used, or a mineral oil and a synthetic oil may be used in combination.

Examples of mineral oils include: a paraffin-based mineral oil, an intermediate-based mineral oil and a naphthene-based mineral oil, which are obtained by an usual purification method such as solvent purification and hydrogenation purification; a wax produced by the Fischer-Tropsch process or the like (gas-to-liquid wax); and materials produced by isomerization of a mineral oil-based wax.

Examples of synthetic oils include a hydrocarbon-based synthetic oil and an ether-based synthetic oil.

Examples of the hydrocarbon-based synthetic oil include an α-olefin oligomer such as polybutene, polyisobutylene, 1-octene oligomer, 1-decene oligomer and ethylene-propylene copolymer or a hydride thereof, alkylbenzene and alkylnaphthalene.

Examples of the ether-based synthetic oil include polyoxyalkylene glycol and polyphenyl ether.

Among them, as the base oil, the mineral oil is preferred from the viewpoint of the solubility of additives.

Note that such mineral oils and synthetic oils may be used solely, or two or more of them may be used in combination.

The kinetic viscosity of the base oil is not particularly limited. From the viewpoint of cooling characteristics, discharge performance for removed chips, odor and safety, the kinetic viscosity of the base oil at 40° C. is preferably 1 to 10 mm²/s, more preferably 1.2 to 8 mm²/s, even more preferably 1.5 to 5 mm²/s, and particularly preferably 1.5 to 2 mm²/s.

When the kinetic viscosity of the base oil at 40° C. is 10 m²/s or less, the coolability, replacement of a liquid interposed between electrodes, and discharge performance for removed chips are satisfactory, the finish machining area and the machining efficiency for deep hole machining are improved, and the surface texture is satisfactory.

When the kinetic viscosity of the base oil at 40° C. is 1 mm²/s or more, the flash point is high, the risk of fire is small, and the odor is weak. Further, since it is a moderate viscosity, a skin rash is not easily generated, and it is preferred from the viewpoint of the work environment. Moreover, the volatility is low, the amount of an oil consumed is small, and the liquid characteristics do not easily change.

In this specification, the kinetic viscosity at 40° C. means a value measured in accordance with JIS K 2283:2000. When using two or more types of base oils, the aforementioned value means a value of the kinetic viscosity at 40° C. of a base oil obtained by mixing them.

In one embodiment of the present invention, it is preferred that a base oil having a kinetic viscosity at 40° C. of 1 to 5 mm²/s (hereinafter also referred to as a “low-viscosity base oil”) and a base oil having a kinetic viscosity at 40° C. of more than 5 mm²/s but 100 mm²/s or less (hereinafter also referred to as a “medium-viscosity base oil”) are used in combination; it is more preferred that a base oil having a kinetic viscosity at 40° C. of 1.2 to 4.5 mm²/s and a base oil having a kinetic viscosity at 40° C. of 6 to 75 mm²/s are used in combination; and it is even more preferred that a base oil having a kinetic viscosity at 40° C. of 1.5 to 4 mm²/s and a base oil having a kinetic viscosity at 40° C. of 6.5 to 50 mm²/s are used in combination. By combining base oils having the above-described kinetic viscosities, a resin is dissolved in a medium-viscosity base oil and it is diluted with a low-viscosity base oil, thereby obtaining a product having a preferred kinetic viscosity

When using two or more types of low-viscosity base oils or medium-viscosity base oils, the aforementioned values mean values of kinetic viscosities of respective base oils obtained by mixing them.

The content of the base oil is a remaining portion other than the petroleum resin of the component (B) and other optional components. From the viewpoint of the kinetic viscosity of a finished material, the total content of the base oil is preferably 70 to 99% by mass, more preferably 80 to 98% by mass, and even more preferably 85 to 97% by mass based on the total amount of the electric discharge machining oil composition.

In one embodiment of the present invention, when using the low-viscosity base oil and the medium-viscosity base oil in combination, the content of the low-viscosity base oil is preferably 50 to 98% by mass, more preferably 62 to 96% by mass, and even more preferably 70 to 94% by mass based on the total amount of the electric discharge machining oil composition. Further, the content of the medium-viscosity base oil is preferably 1 to 20% by mass, more preferably 2 to 18% by mass, and even more preferably 3 to 15% by mass based on the total amount of the electric discharge machining oil composition. By using the low-viscosity base oil and the medium-viscosity base oil at this quantitative ratio, a preferable low-viscosity oil can be obtained.

(B) Petroleum resin

The petroleum resin to be used in the present invention is characterized in that it is at least one petroleum resin, which is selected from hydrogenated products of copolymers of dicyclopentadiene and an aromatic compound, and which has a softening point of 75 to 185° C. and a number-average molecular weight (Mn) of 670 to 3000. According to a preferred embodiment of the present invention, by combining the base oil and the above-described specific petroleum resin, the vapor film length is decreased, excellent thermal conductivity is obtained, and the machining speed in electric discharge machining can be improved.

As described above, the petroleum resin to be used in the present invention includes at least one petroleum resin, which is selected from hydrogenated products of copolymers of dicyclopentadiene and an aromatic compound.

Examples of the aromatic compound to be used in the present invention includes an aromatic compound having an olefinic unsaturated bond and having 8 or more carbon atoms. Examples thereof include an aromatic compound having an olefinic unsaturated bond and having 8 to 16, 9 to 14 or 10 to 12 carbon atoms. Among them, an aromatic compound having an olefinic unsaturated bond and having 8, 9, 10 or 12 carbon atoms is preferred, an aromatic compound having an olefinic unsaturated bond and having 8 or 9 carbon atoms is more preferred, and an aromatic compound having an olefinic unsaturated bond and having 8 carbon atoms is even more preferred.

Specific examples of the aromatic compound include styrene, α-methylstyrene, β-methylstyrene, vinyltoluene, vinylxylene, indene, methylindene and ethylindene. Among them, styrene and indene are preferred, and styrene is more preferred.

These aromatic compounds may be used solely, or two or more of them may be used in combination.

In one embodiment of the present invention, the content of an aromatic compound unit in the hydrogenated product of the copolymer of dicyclopentadiene and the aromatic compound is preferably 0 to 50% by mass, more preferably 5 to 45% by mass, and even more preferably 10 to 40% by mass based on the aromatic compound. When the content of the aromatic compound unit is within the above-described range, the vapor film length is decreased, excellent thermal conductivity is obtained, and the machining speed in electric discharge machining can be improved.

The softening point of the petroleum resin to be used in the present invention is 75 to 185° C., preferably 85 to 165° C., and more preferably 95 to 145° C. When the softening point is within the above-described range, the vapor film length measured by the cooling performance test based on JIS K 2242 is decreased, and the machining speed in electric discharge machining is improved. When the softening point of the petroleum resin is lower than 75° C., the vapor film length is increased, and a desired machining speed cannot be obtained. When the softening point of the petroleum resin is higher than 185° C., handling properties at the time of the production of an electric discharge machining oil may be deteriorated.

In this specification, the softening point of the petroleum resin means a softening point measured by the ring-and-ball method of JIS K 2207:2006.

The number-average molecular weight (Mn) of the petroleum resin to be used in the present invention is 670 to 3000, preferably 690 to 2500, more preferably 700 to 2000, even more preferably 750 to 1500, and particularly preferably 830 to 1000. When the number-average molecular weight of the petroleum resin is within the above-described range, the vapor film length in the cooling performance test is decreased, and the machining speed in electric discharge machining is improved. When the number-average molecular weight of the petroleum resin is not within the above-described range, the vapor film length is increased and a desired machining speed cannot be obtained.

In this specification, the number-average molecular weight (Mn) of the petroleum resin means a number-average molecular weight measured by the VPO method.

In one embodiment of the present invention, the hydrogenated product of the copolymer of dicyclopentadiene and the aromatic compound is a partially hydrogenated product or completely hydrogenated product, wherein not only an olefinic unsaturated bond, but also an aromatic ring is hydrogenated.

The bromine number of the hydrogenated product of the copolymer of dicyclopentadiene and the aromatic compound is preferably 0 to 40 g/100 g, more preferably 2 to 20 g/100 g, and even more preferably 3 to 10 g/100 g. In this specification, the bromine number of the hydrogenated product of the copolymer of dicyclopentadiene and the aromatic compound is a value measured in accordance with JIS K2605:1996.

As the petroleum resin, materials may be used solely, or two or more of them may be used in combination.

In the case of using two or more types of petroleum resins, values of the softening point, the number-average molecular weight (Mn), the content of the aromatic compound unit and the bromine number mean values of the respective petroleum resins.

In the present invention, the petroleum resin can be produced, for example, by the method described in International Publication WO2004/056882 pamphlet. Further, a commercially available product may also be used as the petroleum resin.

From the viewpoint of the kinetic viscosity of the electric discharge machining oil and the vapor film length, the total content of the petroleum resin is preferably 1 to 20% by mass, more preferably 2 to 15% by mass, and even more preferably 3 to 10% by mass based on the total amount of the electric discharge machining oil composition.

(C) Other additives

In the electric discharge machining oil composition of the present invention, in addition to the components (A) and (B), an anti-rust agent, a defoaming agent, an antioxidant, a metal deactivator, etc. may be blended to an extent that does not inhibit the effects of the present invention.

Examples of the anti-rust agent include an alkylbenzene sulfonate, a dinonylnaphthalene sulfonate, an alkenyl succinic acid ester and a polyhydric alcohol ester. The blending amount thereof is preferably about 0.01 to 5% by mass, more preferably 0.05 to 3% by mass, and even more preferably 0.1 to 2% by mass based on the total amount of the electric discharge machining oil composition.

Examples of the defoaming agent include silicone oil, fluorosilicone oil and fluoroalkyl ether. The blending amount thereof is preferably about 0.01 to 5% by mass, more preferably 0.05 to 3% by mass, and even more preferably 0.1 to 2% by mass based on the total amount of the electric discharge machining oil composition.

Examples of the antioxidant include a phenol-based antioxidant and an amine-based antioxidant.

Examples of the phenol-based antioxidant include 4,4′-methylenebis(2,6-di-t-butylphenol) (DBPC); 4,4′-bis(2,6-di-t-butylphenol); 4,4′-bis(2-methyl-6-t-butylphenol); 2,2′-methylenebis(4-ethyl-6-t-butylphenol); 2,2′-methylenebis(4-methyl-6-t-butylphenol); 4,4′-butylidenebis(3-methyl-6-t-butylphenol); 4,4′-isopropylidenebis(2,6-di-t-butylphenol); 2,2′-methylenebis(4-methyl-6-nonylphenol); 2,2′-isobutylidenebis(4,6-dimethylphenol); 2,2′-methylenebis(4-methyl-6-cyclohexylphenol); 2,6-di-t-butyl-4-methylphenol; and 2,6-di-t-butyl-4-ethylphenol.

Examples of the amine-based antioxidant include: a monoalkyldiphenylamine-based antioxidant such as monooctyldiphenylamine and monononyldiphenylamine; a dialkyldiphenylamine-based antioxidant such as 4,4′-dibutyldiphenylamine, 4,4′-dipentyldiphenylamine, 4,4′-dihexyldiphenylamine, 4,4′-diheptyldiphenylamine, 4,4′-dioctyldiphenylamine and 4,4′-dinonyldiphenylamine; a polyalkyldiphenylamine-based antioxidant such as tetrabutyldiphenylamine, tetrahexyldiphenylamine, tetraoctyldiphenylamine and tetranonyldiphenylamine; and a naphthylamine-based antioxidant.

In the present invention, such phenol-based and amine-based antioxidants may be used solely, or two or more of them may be used in combination. Further, in view of the balance between the antioxidant effect and economic efficiency, etc., the blending amount of the antioxidant is preferably about 0.01 to 5% by mass, more preferably 0.05 to 3% by mass, and even more preferably 0.1 to 1% by mass based on the total amount of the electric discharge machining oil composition.

The metal deactivator is mainly used as a copper corrosion inhibitor, and examples thereof include benzotriazole, imidazoline, a pyrimidine derivative, thiadiazole and thiadiazole. These materials may be used solely, or two or more of them may be used in combination. The blending amount thereof is preferably about 0.01 to 1% by mass, more preferably 0.02 to 0.8% by mass, and even more preferably 0.03 to 0.5% by mass based on the total amount of the electric discharge machining oil composition.

As an electrode of an electric discharge machine, copper is usually used. By blending the metal deactivator in an amount within the above-described range, the oxidation catalyst action of a metal oxide of copper or the like, a slight amount of which is mixed in the electric discharge machining oil composition, can be suppressed.

In the electric discharge machining oil composition of the present invention, the total content of the components (A) and (B) is preferably 70 to 100% by mass, more preferably 80 to 100% by mass, even more preferably 85 to 100% by mass, particularly preferably 90 to 100% by mass, and still more preferably 95 to 100% by mass based on the total amount of the electric discharge machining oil composition, since in this case, the effect of improving the machining speed in electric discharge machining tends to be easily obtained.

The electric discharge machining oil composition of the present invention is appropriate for use as an electric discharge machining liquid for subjecting a workpiece to electric discharge machining.

The kinetic viscosity of the electric discharge machining oil composition of the present invention at 40° C. is 1 to 10 mm²/s, preferably 1.2 to 8 mm²/s, and more preferably 1.5 to 5 mm²/s. When the kinetic viscosity of the electric discharge machining oil composition of the present invention at 40° C. is within the above-described range, the machining speed in electric discharge machining can be improved. When the kinetic viscosity is not within the above-described range, the odor may become stronger.

As described above, in this specification, the kinetic viscosity at a predetermined temperature, i.e., 40° C. means a value measured in accordance with JIS K2283:2000.

According to a preferred embodiment of the present invention, the electric discharge machining oil composition of the present invention can decrease the vapor film length (s) that is measured by the cooling performance test based on JIS K 2242, and the vapor film length can be adjusted to, for example, less than 4.8, preferably 4.7 or less, and more preferably 4.6 or less. For this reason, excellent thermal conductivity is obtained, and the machining speed in electric discharge machining can be improved. Note that the lower limit of the vapor film length (s) is not particularly limited, but it is usually about 3.

Further, according to a preferred embodiment of the present invention, it is possible to provide an electric discharge machining oil composition having a long life and excellent durability.

2. Method for producing electric discharge machining oil composition

The method for producing the electric discharge machining oil composition of the present invention is characterized in that the composition comprises:

a base oil (A); and

at least one petroleum resin (B), which is selected from hydrogenated products of copolymers of dicyclopentadiene and an aromatic compound, and which has a softening point of 75 to 185° C. and a number-average molecular weight (Mn) of 670 to 3000, wherein the kinetic viscosity of the electric discharge machining oil composition at 40° C. is 1 to 10 mm²/s.

and that the method includes mixing the component (A) and the component (B).

The components (A) and (B) to be used in the production method of the present invention are as described in “1. Electric discharge machining oil composition” above. The contents of the components (A) and (B) in the electric discharge machining oil composition and optional additives are also as described above. By suitably adjusting the contents of the components (A) and (B) and optional additives, the kinetic viscosity at 40° C. can be adjusted to be within the range of 1 to 10 mm²/s.

In one embodiment of the production method of the present invention, the temperature of the medium-viscosity base oil included in the component (A) is adjusted to, for example, 100° C. or higher, preferably 110° C. or higher, and more preferably 120° C. or higher to dissolve the component (B) therein, and after that, the obtained composition is cooled to, for example, 50° C. or lower, preferably 45° C. or lower, and more preferably 40° C. or lower to dissolve the other components therein. By dissolving the component (B) in the medium-viscosity base oil in advance in this way, a more homogeneous electric discharge machining oil composition can be obtained.

3. Electric discharge machining method

The electric discharge machining method of the present invention includes interposing the electric discharge machining oil composition of the present invention between a workpiece and an electrode, and generating an electric discharge between the workpiece and the electrode in this state to machine the workpiece. Examples of the workpiece in the electric discharge machining method of the present invention include a cemented carbide and an exotic metal (e.g., titanium and carbide). By using the electric discharge machining method of the present invention, these workpieces can be cut to have a complicated contour.

According to a preferred embodiment of the present invention, by using the electric discharge machining oil composition of the present invention, the machining speed for the workpiece can be improved.

### Examples

Hereinafter, the present invention will be described in more detail by way of examples, but the present invention is not limited to the examples.

Electric discharge machining oil compositions were prepared by using base oils and additives shown in Table 1, and the compositions were evaluated as described below.

TABLE 1

| | | Number- | | | | | | | |
|---|---|---|---|---|---|---|---|---|---|
| | | average | | | | | | | |
| | | molecular | | | | | Comp. | Comp. | Comp. |
| | | weight (Mn) | Ex. 1 | Ex. 2 | Ex. 3 | Ex. 4 | Ex. 1 | Ex. 2 | Ex. 3 |
| Base oil | A: kinetic viscosity | | 88.0 | 88.0 | 88.0 | 88.0 | 88.0 | 88.0 | 88.0 |
| (% by mass) | at 40° C. 1.6 mm²/s | | | | | | | | |
| | B: kinetic viscosity | | 6.0 | 6.0 | 6.0 | 6.0 | 6.0 | 6.0 | 6.0 |
| | at −40° C. 7.1 mm²/s | | | | | | | | |
| | C: kinetic viscosity | | | | | | | | |
| | at 40° C. 2.1 mm²/s | | | | | | | | |
| Petroleum | A: softening | 700 | 6.0 | | | | | | |
| resin | point 100° C. | | | | | | | | |
| (% by mass) | B: softening | 760 | | 6.0 | | | | | |
| | point 110° C. | | | | | | | | |
| | C: softening | 660 | | | | | 6.0 | | |
| | point 100° C. | | | | | | | | |
| | D: softening | 820 | | | 6.0 | | | | |
| | point 125° C. | | | | | | | | |
| | E: softening | 900 | | | | 6.0 | | | |
| | point 140° C. | | | | | | | | |
| | F: softening | — | | | | | | 6.0 | |
| | point 99° C. | | | | | | | | |
| | G: softening | 1300 | | | | | | | 6.0 |
| | point 99° C. | | | | | | | | |
| | H: softening | 1000 | | | | | | | |
| | point 94° C. | | | | | | | | |
| | I: softening | 900 | | | | | | | |
| | point 103° C. | | | | | | | | |
| | J: softening | 400 | | | | | | | |
| | point 105° C. | | | | | | | | |
| Terpene resin | U: softening | | | | | | | | |
| Terpene resin | point 115° C. | | | | | | | | |
| derivative | W: softening | | | | | | | | |
| (% by mass) | point 115° C. | | | | | | | | |
| Rosin/Rosin | AD: softening | | | | | | | | |
| derivative | point 80° C. | | | | | | | | |
| (% by mass) | AE: softening | | | | | | | | |
| | point 120° C. | | | | | | | | |
| Total | | | 100.0 | 100.0 | 100.0 | 100.0 | 100.0 | 100.0 | 100.0 |
| Kinetic viscosity at 40° C. (mm²/s) | | | 2.127 | 2.138 | 2.155 | 2.185 | 2.128 | 2.209 | 2.196 |
| Cooling | Vapor film | | 4.32 | 4.39 | 4.58 | 3.63 | 4.80 | 5.46 | 5.60 |
| performance | length (s) | | | | | | | | |
| | | Comp. | Comp. | Comp. | Comp. | Comp. | Comp. | Comp. | Comp. |
| | | Ex. 4 | Ex. 5 | Ex. 6 | Ex. 7 | Ex. 8 | Ex. 9 | Ex. 10 | Ex. 11 |
| Base oil | A: kinetic viscosity | 88.0 | 88.0 | 88.0 | 88.0 | 88.0 | 88.0 | 88.0 | |
| (% by mass) | at 40° C. 1.6 mm²/s | | | | | | | | |
| | B: kinetic viscosity | 6.0 | 6.0 | 6.0 | 6.0 | 6.0 | 6.0 | 6.0 | |
| | at −40° C. 7.1 mm²/s | | | | | | | | |
| | C: kinetic viscosity | | | | | | | | 100.0 |
| | at 40° C. 2.1 mm²/s | | | | | | | | |
| Petroleum | A: softening | | | | | | | | |
| resin | point 100° C. | | | | | | | | |
| (% by mass) | B: softening | | | | | | | | |
| | point 110° C. | | | | | | | | |
| | C: softening | | | | | | | | |
| | point 100° C. | | | | | | | | |
| | D: softening | | | | | | | | |
| | point 125° C. | | | | | | | | |
| | E: softening | | | | | | | | |
| | point 140° C. | | | | | | | | |
| | F: softening | | | | | | | | |
| | point 99° C. | | | | | | | | |
| | G: softening | | | | | | | | |
| | point 99° C. | | | | | | | | |
| | H: softening | 6.0 | | | | | | | |
| | point 94° C. | | | | | | | | |
| | I: softening | | 6.0 | | | | | | |
| | point 103° C. | | | | | | | | |
| | J: softening | | | 6.0 | | | | | |
| | point 105° C. | | | | | | | | |
| Terpene resin | U: softening | | | | 6.0 | | | | |
| Terpene resin | point 115° C. | | | | | 6.0 | | | |
| derivative | W: softening | | | | | | | | |
| (% by mass) | point 115° C. | | | | | | | | |
| Rosin/Rosin | AD: softening | | | | | | 6.0 | | |
| derivative | point 80° C. | | | | | | | 6.0 | |
| (% by mass) | AE: softening | | | | | | | | |
| | point 120° C. | | | | | | | | |
| Total | | 100.0 | 100.0 | 100.0 | 100.0 | 100.0 | 100.0 | 100.0 | 100.0 |
| Kinetic viscosity at 40° C. (mm²/s) | | 2.110 | 2.157 | 2.110 | 2.140 | 2.130 | *1 | *1 | 2.119 |
| Cooling | Vapor film | 6.13 | 5.06 | 4.80 | 5.40 | 5.32 | *1 | *1 | 9.98 |
| performance | length (s) | | | | | | | | |

*1 Unusable because the resin did not dissolve in the base oil.

The components in the table are as described below.

1) Petroleum resin A: DCPD (dicyclopentadine)/aromatic copolymer-based partially hydrogenated product, bromine number: 5 g/100 g
2) Petroleum resin B: DCPD (dicyclopentadiene)/aromatic copolymer-based partially hydrogenated product, bromine number: 6 g/100 g
3) Petroleum resin C: DCPD (dicyclopentadiene)/aromatic copolymer-based completely hydrogenated product, bromine number: 2.5 g/100 g
4) Petroleum resin D: DCPD (dicyclopentadiene)/aromatic copolymer-based completely hydrogenated product, bromine number: 2.5 g/100 g
5) Petroleum resin E: DCPD (dicyclopentadiene)/aromatic copolymer-based completely hydrogenated product, bromine number: 2 g/100 g
6) Petroleum resin F: aliphatic petroleum resin (C5), petroleum resin obtained by using an aliphatic monomer having 5 carbon atoms as a raw material
7) Petroleum resin G: aliphatic petroleum resin (C5), petroleum resin obtained by using an aliphatic monomer having 5 carbon atoms as a raw material
8) Petroleum resin H: aliphatic petroleum resin (C5), petroleum resin obtained by using an aliphatic monomer having 5 carbon atoms as a raw material
9) Petroleum resin I: aliphatic/aromatic petroleum resin (C5/C9), petroleum resin obtained by using an aliphatic monomer having 5 carbon atoms and an aromatic monomer having 9 carbon atoms as raw materials
10) Petroleum resin J: hydrogenated dicyclopentadiene-based resin
11) Terpene resin U: terpene polymer (homopolymer of terpene monomer)
12) Terpene resin derivative W: hydrogenated terpene resin
13) Rosin AD: rosin ester, acid value: 20 or less
14) Rosin derivative AE: polymerized rosin ester, acid value: 16 or less
<Evaluation methods>
(1) Kinetic viscosity at 40° C.

The measurement was carried out at 40° C. in accordance with JIS K 2283:2000.

(2) Cooling performance test (vapor film length (s))

The vapor film length (s) was measured by the cooling performance test based on JIS K 2242.

<Evaluation results>

The results are shown in Table 1.

As shown in Table 1, it was understood that the vapor film length in the cooling performance test is decreased by using the electric discharge machining oil composition of the present invention (Examples 1-4).

Meanwhile, when the number-average molecular weight is smaller, the vapor film length is increased even when the resin structure of the petroleum resin is the same (Comparative Example 1). It was also understood that the vapor film length is increased when the resin structure of the petroleum resin is different (Comparative Examples 2-6). It was also understood that when using another resin such as a terpene resin and a rosin resin instead of the petroleum resin, the vapor film length is increased, or such another resin cannot be used because it does not dissolve in the base oil (Comparative Examples 7-10). Note that when using only the base oil, the vapor film length was about 2 to 3 times longer (Comparative Example 11).

Thus, it is considered that, by using a specific petroleum resin in the electric discharge machining oil composition of the present invention and adjusting the kinetic viscosity at 40° C. within a predetermined range, the vapor film length in the cooling performance test is decreased and thermal conductivity is improved, and for this reason, the machining speed in electric discharge machining is increased.

Hereinafter, by using the electric discharge machining oil compositions of Example 1 and Comparative Example 11, the relationship between the vapor film length in the cooling performance test and the machining speed was examined.

<Evaluation method>

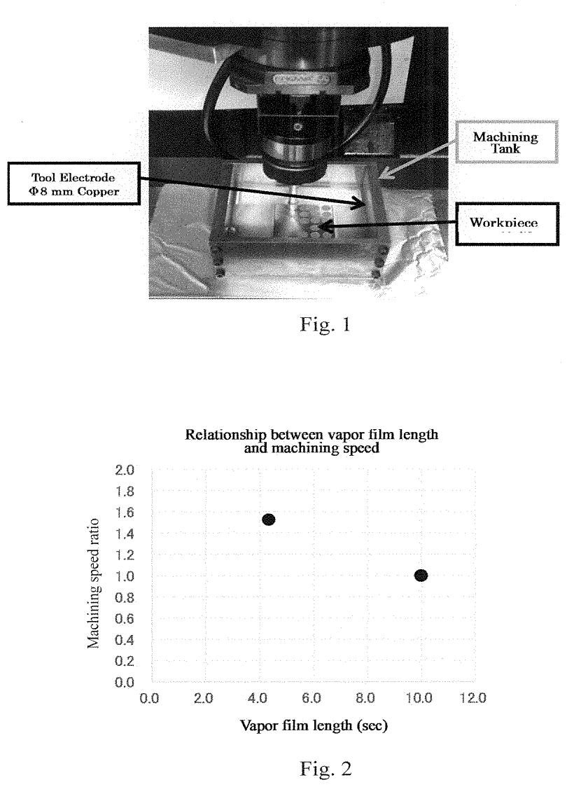

As a processing machine, the processing machine described in FIG. 1 (“AQ35LR” manufactured by Sodick) was used. The machining speed (g/min) of each of the electric discharge machining oil compositions was measured under the machining conditions (rough machining) described in Table 2. The machining speed was obtained based on the weight change of the workpiece before and after machining. Based on the machining speed in the case of using the electric discharge machining oil composition of Comparative Example 11, the machining speed ratio in the case of using the electric discharge machining oil composition of Example 1 was obtained.

TABLE 2

| Electrode polarity | + |
|---|---|
| Open circuit voltage [V] | 90 |
| Peak current [A] | 30 |
| Servo voltage [V] | 40 |
| On time [μs] | 100 |
| Off time [μs] | 45 |
| Electrode jump speed [m/min] | 20 |
| Jump rise time [sec] | 0.05 |
| Jump fall time [sec] | 0.50 |
| Machining time [min] | 5 |

<Evaluation results>

The results are shown in Table 3 and FIG. 2. As shown in Table 3 and FIG. 2, it was confirmed that the machining speed becomes higher when the vapor film length in the cooling performance test is shorter. The results support the consideration that, by using a specific petroleum resin in the electric discharge machining oil composition of the present invention and adjusting the kinetic viscosity at 40° C. within a predetermined range, the vapor film length in the cooling performance test is decreased and the machining speed in electric discharge machining is increased.

TABLE 3

| | Machining speed ratio | Vapor film length |
|---|---|---|
| Example 1 | 1.53 | 4.32 |
| Comparative | 1.00 | 9.98 |
| Example 11 | (reference) | |

### INDUSTRIAL APPLICABILITY

The electric discharge machining oil composition of the present invention can be suitably used as an electric discharge machining liquid. According to a preferred embodiment of the present invention, by using the electric discharge machining oil composition of the present invention, the machining speed in electric discharge machining can be improved.

1: An electric discharge machining oil composition, comprising:
a base oil; and
a petroleum resin, which is hydrogenated product of a copolymer of dicyclopentadiene and an aromatic compound, and which has a softening point of from 75 to 185° C. and a number-average molecular weight (Mn) of from 670 to 3000, wherein a kinetic viscosity of the electric discharge machining oil composition at 40° C. is from 1 to 10 mm²/s.

2: The electric discharge machining oil composition according to claim 1, wherein a content of an aromatic compound unit in the petroleum resin is from 0 to 50% by mass based on the aromatic compound.

3: The electric discharge machining oil composition according to claim 1, wherein the hydrogenated product of the copolymer of dicyclopentadiene and the aromatic compound is a partially hydrogenated product or a completely hydrogenated product.

4: The electric discharge machining oil composition according to claim 1, wherein the hydrogenated product of the copolymer of dicyclopentadiene and the aromatic compound has a bromine number of from 0 to 40 g/100 g.

5: The electric discharge machining oil composition according to claim 1, wherein a total content of the petroleum resin is from 1 to 20% by mass based on a total amount of the electric discharge machining oil composition.

6: The electric discharge machining oil composition according to claim 1, wherein a total content of the base oil is from 70 to 99% by mass based on a total amount of the electric discharge machining oil composition.

7: The electric discharge machining oil composition according to claim 1, having a kinetic viscosity at 40° C. of from 1.2 to 8 mm²/s.

8: The electric discharge machining oil composition according to claim 1, wherein the base oil comprises a low-viscosity base oil having a kinetic viscosity at 40° C. of from 1 to 5 mm²/s and a medium-viscosity base oil having a kinetic viscosity at 40° C. of more than 5 mm²/s but 100 mm²/s or less.

9: A method for producing an electric discharge machining oil composition, the method comprising:
mixing a base oil and a petroleum resin,
wherein the electric discharge matching oil composition comprises:
the base oil; and
the petroleum resin, which is a hydrogenated product of a copolymer of dicyclopentadiene and an aromatic compound, and which has a softening point of from 75 to 185° C. and a number-average molecular weight (Mn) of from 670 to 3000, wherein a kinetic viscosity of the electric discharge machining oil composition at 40° C. is from 1 to 10 mm².

10: An electric discharge machining method, comprising:
interposing the electric discharge machining oil composition according to claim 1 between a workpiece and an electrode, and
generating an electric discharge between the workpiece and the electrode while maintaining the interposing, thereby machining the workpiece.
